(19) United States
(12) Patent Application Publication
(10) Pub. No.: US 2026/0276497 A1
(43) Pub. Date: Sep. 17, 2026

(54) DEVICE FOR CONDITIONING A FILTRATION MEMBRANE FOR ANALYSIS BY SOLID-PHASE CYTOMETRY ON SAID FILTRATION MEMBRANE, AND ASSOCIATED METHODS

(71) Applicant: BIOMÉRIEUX, Marcy L'Etoile (FR)

(72) Inventors: Eric LALOUM, Lyon (FR); Céline LAMOTTE, Oullins (FR); Edgard MINASSIAN, Lentilly (FR)

(73) Assignee: BIOMÉRIEUX, Marcy L'Etoile (FR)

(21) Appl. No.: 19/163,051

(22) PCT Filed: Mar. 12, 2024
(86) PCT No.: PCT/FR2024/000029

§ 371 Date: Sep. 8, 2025

(30) Foreign Application Priority Data
Mar. 14, 2023 (FR) FR2302325

(51) Int. Cl. G01N 1/40; G01N 21/64

(52) U.S. Cl. CPC G01N 1/4077; G01N 21/6428; G01N 2001/4088; G01N 2021/6439

(57) ABSTRACT

A filtration device for use in solid-phase cytometry, the filtration device being configured to filter a biological sample likely to contain microorganisms and to allow its analysis, the filtration device including: a filtration membrane configured to filter the biological sample, the filtration membrane having an upper face and a lower face, wherein the filtration device further includes at least: a coverslip arranged above the upper face of the filtration membrane, the coverslip being arranged so as to cover the entirety of the upper face of the membrane, an interstitial space formed between the coverslip and the upper face of the filtration membrane, the interstitial space being shaped to receive a fluid.

### TECHNICAL FIELD OF THE INVENTION

The invention relates to the technical field of solid-phase cytometry and more particularly to the devices and methods relating to operations on the filtration membrane allowing such analysis.

### TECHNOLOGICAL BACKGROUND OF THE INVENTION

The company bioMérieux has designed, developed and markets the SCANRDI® method based on solid-phase cytometry analysis for the rapid microbiological control of filterable samples. This method is notably used in the pharmaceutical field for the control of environments and processes for the production of sterile products (process water for example) as well as for release testing of finished products (sterility testing of injectable products for example).

This method is based on (i) reagents and consumables, including in particular a dedicated filtration membrane (described in detail below) and fluorescent labeling reagents, (ii) a solid-phase cytometry instrumental platform, such as the SCANRDI® instrument marketed by the company bioMérieux, (iii) algorithms for detecting and counting microorganisms.

As explained above, one of the central elements of the analysis is a filtration membrane. This membrane is porous, with a pore density (~1.5×10⁸ pores/cm²) and a pore size of less than 0.4 μm, making it possible to retain all microorganisms (except viruses). Said filtration membrane is referred to as a “surface” membrane wherein the objects are retained on the upper face and not in the volume of the membrane, and has a small thickness of between 20 μm and 30 μm. Furthermore, the filtration membrane is preferably made of polymer: polyester (PET) or polycarbonate, pierced by track-etching, and colored black to reduce its intrinsic fluorescence (high for plastic materials) and thus increase the contrast in the detection of microorganisms by fluorescence.

The membrane is flexible and can be used as is as a consumable to be handled (placement/removal on a filtration support, on pads, etc.) but can advantageously be pre-attached and stretched in a suitable support, facilitating coupling with other accessories necessary for the method, such as a filtration funnel, a support for a filtration manifold, an impregnation pad.

On the other hand, there are also surface filtration membranes based on inorganic materials, such as ceramics, which are natively rigid, with pores machined by lithography. Such membranes are generally not colored because they have very low intrinsic fluorescence.

Solid-phase cytometry is highly efficient: it can detect the presence of a single microbial cell in a sample volume of up to several tens of ml in just 3 hours.

However, its use is limited by a number of factors, in particular:
the fact that the protocol is essentially manual and somewhat tedious (see details below),
the fact that the sample is transferred from one piece of equipment to another (filtration manifold, incubator, SCANRDI®, microscope), with the potential for secondary contamination linked to the test itself,
the fact that confirmation of any contaminants requires careful examination by fluorescence microscopy, which is not always easy because of the risk of photobleaching and associated phototoxicity,
the fact that some microbes detected cannot subsequently grow back on a culture medium owing to the overall stress caused by the method.

Solid-phase cytometry is carried out in several steps as shown in FIG. 1: filtration 101, counterstaining 105, activation 106, labeling 102, detection 103 and confirmation 104. The steps of counterstaining 105, activation 106 and confirmation 104 are optional. Optionally, a culturing step 107 may be implemented after confirmation 104.

The first step consists in filtering the entire volume of the sample to be analyzed through a filtration membrane, in a controlled environment: a biological safety cabinet (BSC) or under a laminar flow hood. To ensure that the entire sample passes through the membrane, a second sterile fluid is usually filtered after it, to collect any residue clinging to the filter funnel.

In a second step, and optionally, a counterstaining reagent is filtered, following the sample, making it possible to increase the contrast of the microorganisms. To be effective, this step must be carried out primarily from above the membrane.

The next step is labeling, possibly preceded by an activation phase to increase the effectiveness of the label. These two steps are preferably carried out from the lower face of the filtration membrane, with a medium placed in intimate contact under the filtration membrane. The reagent diffuses through the filtration membrane to the upper face of the filtration membrane. It can be assumed that a very thin layer of supernatant liquid forms on the surface of the membrane, a few microns or even tens of microns thick. When exposed to air, this layer can dry out, creating an additional stress factor for microbes, the viability and reproductive capacity of which must be maintained. On the other hand, too great a liquid layer can interfere with the optical examination of the surface with a loss of focus. Generally, the medium is soaked so that there is no visible liquid layer on the surface of the filtration membrane.

During the detection step, the filtration membrane is generally placed in intimate contact with a soaked pad so as to ensure that it is flat and prevent it from drying out. Specific fluorescence signals from microorganisms may be detected using various optical means, but in all cases there is relatively long exposure to an excitation light (laser or LED) and the risks of drying out and contamination persist.

Detection may be followed by a step of confirmation, allowing the objects detected to be viewed at high resolution, using a high numerical aperture microscope, and confirmed to be microbes. As with the detection step, and even more critically, it is important to control the flatness of the membrane and the thin layer of supernatant liquid, if any, on the surface in order to guarantee the quality of the images acquired (resolution and contrast).

If the presence of microorganisms is detected, and optionally, the membrane can then be placed on agar or in a liquid culture medium in order to grow them so that they can be identified as accurately as possible.

In the prior art currently, the filtration membrane is always exposed to air, except during the steps of transfer from one station to another wherein a protective cover may possibly be placed over the membrane, its only property being to limit possible contamination of the sample by the environment or vice versa, the cover being removed for the detection step of the method.

### SUBJECT MATTER OF THE INVENTION

The invention aims to improve the existing system described above and in particular to:
maintain the integrity of the sample throughout the analysis, from filtration to the results of detection, or even the identification of contaminants,
reduce the risks of the environment being polluted by the sample,
reduce the risk of contamination of the sample during the process (secondary contamination),
reduce the phototoxicity of the analysis,
reduce photobleaching,
promote post-analysis regrowth,
allow easier handling of the membrane and in particular allow it to be placed upside down, with its upper face facing downward, in an inverted microscope,
allow the use of immersion objectives and therefore improve the quality of the images during the step of confirmation under the microscope (the use of immersion objectives for microscopic imaging with a very high numerical aperture allows better light collection and better image quality).

To this end, the invention relates to a device for conditioning a filtration membrane for analysis by solid-phase cytometry, said conditioning device comprising:
a filtration membrane configured to filter a biological sample, the filtration membrane having an upper face and a lower face,
characterized in that the conditioning device further comprises at least:
a coverslip arranged above the upper face of the filtration membrane, the coverslip being arranged so as to cover the entire upper face of the filtration membrane,
an interstitial space formed between the coverslip and the upper face of the filtration membrane, the interstitial space being shaped to receive a fluid.

The invention aims to maintain the integrity of the sample by controlling the state of the upper face of the filtration membrane during the steps of the protocol thanks to the application of a coverslip and the interstitial space. This avoids pollution of the sample by the analysis environment (mainly the equipment with which it is in direct contact), contamination of the environment (mainly equipment) by the sample, and therefore limits cross-contamination from one sample to another. Pollution can be microbiological but can also arise from particles and dust in the environment.

In addition, the coverslip makes it possible to limit any accidental direct contact with the surface of the filtration membrane, friction for example, and to limit the effects of poor handling, such as, for example, the membrane not being gripped properly, or the membrane falling, etc. while also making it possible to avoid contact with the surrounding air, thus limiting drying out of the filtration membrane or oxidation.

Furthermore, the presence of a fluid in the interstitial space, with a predetermined thickness, is compatible with the optical examination of the surface of the filtration membrane and has a specific beneficial effect of dissipation which limits “photobleaching” during fluorescence detection.

The combined presence of the coverslip and the interstitial space with the interstitial fluid has other advantages, including:
specific control of a medium favorable to the metabolism of the microorganisms (aerobic or anaerobic),
prevention of the toxic effects of oxygen specific to fluorescence analysis, in particular quenching and phototoxicity,
the possibility of using an immersion objective.

According to one feature of the invention, the coverslip has optical qualities allowing microscopic examination. More specifically, the coverslip is transparent and for example made of borosilicate glass or quartz, or from polymer (acrylate resins, crystal polystyrene). The material selected depends in particular on the mechanical constraints to be taken into account, the size of the membrane to be covered and the refractive index of the interstitial fluid placed between the upper face of the membrane and the lower face of the coverslip (from 1.35 for water up to 1.52 for immersion oils).

According to another feature of the invention, the coverslip has a thickness of between 100 μm and 300 μm.

According to one feature of the invention, the coverslip is rigidly secured to the filtration membrane while maintaining the interstitial space.

According to one feature of the invention, the coverslip may be rigidly secured to the membrane by adhesive bonding and/or clipping and/or sealing.

According to one feature of the invention, the interstitial space has a predetermined thickness of between 100 μm and 500 μm and preferably at least 250 μm. Thanks to this space, it is possible to guarantee the filtration step (by limiting capillary forces/fluidic resistance due to the coverslip) and the optical examination after filtration.

The minimum limit of 100 μm for the thickness of the interstitial space is determined by the constraints of manufacturing the parts by injection/molding and by the inherent thickness of the filtration membrane itself, approximately 25 μm. Furthermore, in the context of the subsequent growth of the remaining microorganisms on the surface of the upper face of the filtration membrane, the thickness must be sufficient so as not to restrict the development of micro-colonies.

In the option wherein the coverslip is positioned above the filtration membrane before the filtration step, the minimum thickness of the interstitial space is at least 250 μm, which ensures that filtration takes place uniformly across the entire filtration membrane, without the risk of mechanical breakage, tearing of the filtration membrane or leakage. To be specific, with such a thickness, and in the context of a depression applied between the upper face and the lower face of the filtration membrane, the entire volume above the filtration membrane is first uniformly filled with interstitial fluid, by virtue of the fluidic resistance of the filtration membrane which is greater than the capillary friction forces linked to the coverslip, before the interstitial fluid then passes through the filtration membrane toward the area of the filtration membrane under depression.

The maximum limit of 500 μm for the thickness of the interstitial space is determined by optical constraints and in particular the maximum working distance achievable for standard high magnification objectives, around 1 mm, which must cover the thickness of the coverslip plus said thickness of the interstitial space. Furthermore, depending on the fluid used to fill this interstitial space, and in particular its absorption, diffusion or fluorescence characteristics, this maximum limit will be further reduced to guarantee the best imaging quality.

Preferably, an interstitial space thickness of around 250 μm makes it possible to have a device that can be used throughout the analysis protocol, from the filtration of the biological sample to the confirmation step under the microscope and thereafter, during any culturing for the purposes of identification.

According to one feature of the invention, the filtration device comprises an interstitial fluid housed in the interstitial space, the fluid being a liquid buffer or a gel.

Advantageously, the fluid is a liquid buffer optionally containing a surfactant, such as for example a polysorbate, also known under the trade name Tween®, in order to improve the wettability of said buffer.

According to one feature of the invention, the interstitial fluid is transparent with a low diffusing capacity, making it compatible with high-resolution optical examination of the filtration membrane.

Advantageously, the interstitial fluid is a gel or liquid gelled using a gelling agent, for example Kappa Carrageenan. In this configuration, the liquid is introduced at a temperature between 45° C. and 50° C. and then gels rapidly at room temperature in the interstitial space.

According to one feature of the invention, the interstitial fluid may contain a reducing reagent in solution which aims to hydrolyze the fluorophore molecules present in the matrix, thereby increasing the contrast between the labeled microorganisms (fluorophore trapped in the cells) and the background.

According to one feature of the invention, the interstitial fluid may be supplemented with soluble nutrients to promote microbial growth.

According to one feature of the invention, the reagents added to the interstitial fluid may be encapsulated in microparticles allowing their controlled and programmed release throughout the protocol.

Alternatively, the interstitial fluid may also be a mixture of oil, paraffin or water.

According to one feature of the invention, the filtration membrane may be made of polymer, polycarbonate or polyethylene terephthalate (PET) or of rigid composite material.

According to one feature of the invention, the filtration membrane may be made of polymer and pierced by means of a “track-etched” process, which means that the pores are created in 2 steps: a first step in which the plastic film is bombarded with high-energy particles in order to generate impacts on the surface (“tracks”), a second step in which the plastic film is then subjected to chemical attack (“etching”) in a bath, wherein the pores are formed from the tracks previously made. In this process, the pore density is determined by the first step (track density), while the pore size is controlled by the etching conditions.

According to one feature of the invention, the membrane may be made of ceramic and etched/pierced by laser lithography.

According to one feature of the invention, the filtration membrane may be colored or metallized.

According to one feature of the invention, the filtration device comprises at least one support on which the filtration membrane is positioned, said support having at least one port in communication with the upper face of the filtration membrane.

According to one feature of the invention, the support comprises a plurality of ports.

Advantageously, the port(s) allow procedures to be performed on the upper face of the filtration membrane, in particular filtration (by closing one of the two ports) or the introduction of an interstitial fluid after filtration.

According to one feature of the invention, at least one port of the support is configured to allow the interstitial space to be filled with the interstitial fluid.

Advantageously, the support for the filtration membrane is a frame on which the filtration membrane is stretched and attached. Advantageously, the frame is positioned around the periphery of the filtration membrane.

According to one feature of the invention, the support for the filtration membrane has a lower housing provided under the filtration membrane.

Advantageously, the lower housing opens onto the lower face 2b of the filtration membrane.

According to one feature of the invention, the support comprises a lower housing, formed under the filtration membrane, the lower housing being shaped to receive a functionalized cartridge intended to come into contact with the lower face of the membrane.

According to one feature of the invention, the filtration device comprises at least one functionalized cartridge, said functionalized cartridge possibly being a reagent or a culture medium or a medium for activating spores, or a cartridge for fluorescent labeling or a cartridge for deactivating labeling and/or for keeping the filtration membrane soaked.

According to one feature of the invention, the cartridge contains the reagents in the form of a solution in a liquid matrix.

According to one feature of the invention, the cartridge is a pad soaked in reagent.

According to one feature of the invention, the cartridge contains the reagents in a gel matrix.

According to one feature of the invention, the cartridges may be brought into contact one after the other during the protocol; for example, the activation cartridge, then the labeling cartridge and lastly the support cartridge ensuring flatness for detection.

According to one feature of the invention, a single cartridge may be used for several steps, with a mixture of reagents.

According to one feature of the invention, the reagents in the cartridge are encapsulated in microparticles allowing controlled/programmed release. Thus, within a given time interval, or under the effect of a temperature gradient, the particles release the labeling substrate into the medium, which then diffuses toward the filtration membrane and labels the microorganisms of interest. Such a cartridge allows combination of the activation and labeling steps with a single cartridge.

Advantageously, the filtration device further comprises a cover which clipped/adhesively bonded onto the support 6, once the filtration step has been carried out. Such a filtration device according to the invention, once closed and before the detection step, makes it possible to keep the filtration membrane protected and leave it in an incubator for several days to allow the growth of microorganisms on the surface of the filtration membrane, which facilitates the identification of the microorganisms.

Advantageously, the reagent may be in the form of a liquid, gel or soaked pad.

Advantageously, the device also includes a space containing gases, allowing the growth of microbes.

The present invention also relates to a method for microbiological analysis by solid-phase cytometry using a filtration device according to the invention, the analysis method comprising at least the following steps:
a step of filtration of the sample by the filtration membrane;
a step of fluorescence labeling of the microorganisms likely to be present in the biological sample,
a step of detection of the labeled microorganisms, the method being characterized in that it comprises at least one step according to which the coverslip is positioned above the upper face of the filtration membrane of the filtration device.

According to one feature of the invention, the method comprises a step of confirmation of detection by fluorescence microscope, this step being carried out after the detection step or after the labeling step.

According to one feature of the invention, the fluorescence labeling step consists in making the microorganisms fluorescent.

According to one feature of the invention, the fluorescence labeling step may be carried out with a fluorogenic substrate or a reagent or any other means making it possible to achieve fluorescence of the microorganism.

According to one feature of the invention, the sample is in liquid form so as to be filterable. Preferably, the sample is non-biological and is for example: wastewater, injectable chemicals, etc.

According to one feature of the invention, the coverslip is positioned above the upper face of the filtration membrane of the filtration device before the filtration step. After this step of positioning the coverslip, an additional step of adding an interstitial fluid into the interstitial space of the filtration device is carried out after the filtration step, directly after the filtration step or otherwise.

Alternatively and according to one feature of the invention, the coverslip is positioned above the upper face of the filtration membrane of the filtration device after the filtration step. After this step of positioning the coverslip, the interstitial fluid is added into the interstitial space of the filtration device before the detection step, directly after the detection step or otherwise.

According to one feature of the invention, the coverslip may be rigidly secured to the membrane by clipping at any time during the analysis method, once a filtration funnel has been removed.

According to one feature of the invention, if the coverslip is positioned after the filtration step, the sample is injected directly onto the upper face of the filtration membrane via a filtration funnel.

According to one feature of the invention, if the coverslip is positioned before the filtration step, the sample is injected onto the upper face of the filtration membrane via the port(s) of the support for the filtration funnel.

According to one feature of the invention, during the filtration of the sample, whether the coverslip is present or not, a depression may be applied to the lower face of the filtration membrane, making it possible to achieve homogeneous filtration over the entire surface of the filtration membrane, thereby improving the efficiency and speed of filtration.

Advantageously, if the coverslip is present during filtration, the sample in liquid form fills the interstitial space before the suction effect causes it to pass through the pores of the filtration membrane.

According to one feature of the invention, the method may further include a step of adding a counterstaining solution, this addition being carried out by filtration of said solution, after filtration of the sample. As with filtration of the sample, this step is performed through the upper face of the membrane, either via a funnel or via the injection ports, if the coverslip is present.

This counterstaining step is an optional step that makes it possible to reduce endogenous sample fluorescence and non-specific labeling. To be specific, the sample may correspond to various products, more or less complex (solution, suspension, emulsion), possibly with prior preparation to make it filterable (centrifugation, mechanical lysis, chemical lysis). In addition to any microbes labeled with fluorescence, the sample may thus contain intrinsically fluorescent particles or debris. Even if some particles are not natively fluorescent, the exogenous labeling provided by the protocol may not be perfectly specific and may label objects other than microbes, either by direct conversion of the fluorogenic substrate into a fluorophore at an undesired site (not a microbial cell), or by efflux of the fluorophore generated inside a microbial cell through the membrane, by the action of efflux pumps; the fluorophore therefore labels the entire sample, and reduces the contrast. The counterstaining solution therefore masks/covers the sites before the labeling step to prevent/hinder access of the fluorophore.

According to one feature of the invention, the method may comprise a pre-labeling step prior to the labeling step, said pre-labeling step constituting an activation to resuscitate the spores and guarantee optimal enzymatic activity.

According to one feature of the invention, the activation and labeling steps may be carried out with or without a coverslip present on the surface of the membrane.

According to one feature of the invention, the interstitial volume is filled with a fluid after the filtration and counterstaining step and before the activation and labeling step.

According to one feature of the invention, the interstitial space is filled with an interstitial fluid after the activation and labeling step and before the detection step.

According to one feature of the invention, the interstitial fluid may be injected via the ports of the device.

According to one feature of the invention, the interstitial space may be filled from the inner face of the membrane, via diffusion of the liquid through the pores of the membrane.

According to one feature of the invention, the confirmation step, which is optional, may be carried out using an immersion microscopy objective. Indeed, thanks to the presence of the coverslip above the filtration membrane, it is possible to use immersion microscopy objectives with very high numerical aperture (from 40× and NA≥0.6) which therefore have a very high collection power and make it possible both to minimize the dose of light received by the sample and also to improve the resolution of the images. If an immersion objective is used, it is necessary to use an immersion oil compatible with the coverslip material.

Alternatively, the confirmation step may be carried out using an air objective, possibly corrected for the presence of a coverslip.

According to one feature of the invention, the air objective is a 60× objective with 0.7 aperture, used with air, with a long working distance (greater than or equal to 1 mm) allowing focusing over the majority of the range of the interstitial space and with correction for the coverslip (variable correction collar).

### BRIEF DESCRIPTION OF THE FIGURES

The invention will be better understood by virtue of the following description, which relates to embodiments according to the present invention, which are provided by way of non-limiting examples and are explained with reference to the appended schematic figures. The appended schematic figures are listed below:

FIG. 1 is a diagram of a method for microbiological analysis by solid-phase cytometry according to the prior art,

FIG. 2 is a sectional view of the filtration device according to the invention,

FIG. 3 is an exploded sectional view of the filtration device according to the invention,

FIG. 4 is a diagram of possible implementation, with a gel interstitial layer and the thickness of interest for detection,

FIG. 5 is a perspective view of a portion of the support and the filtration membrane of the filtration device,

FIG. 6 is an illustration of the method according to the invention,

FIG. 7 is an alternative embodiment of the method according to the invention.

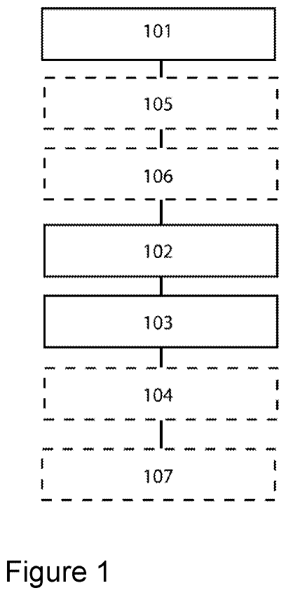

### DETAILED DESCRIPTION

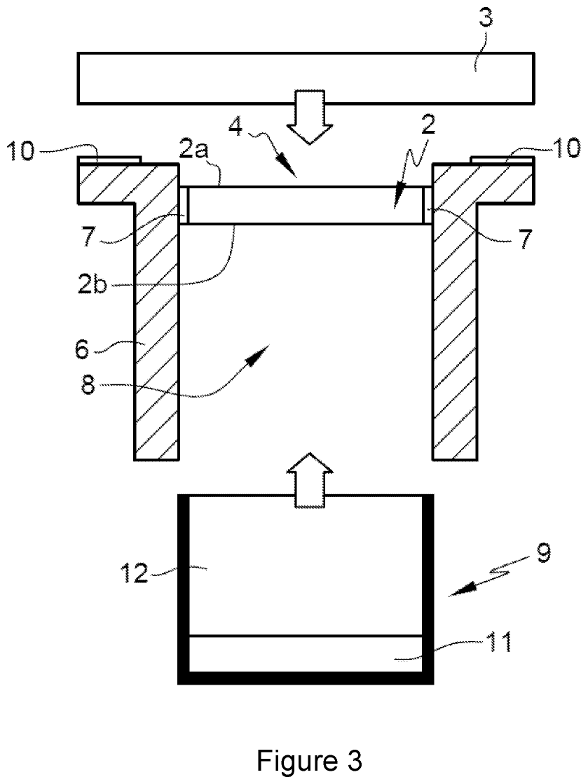

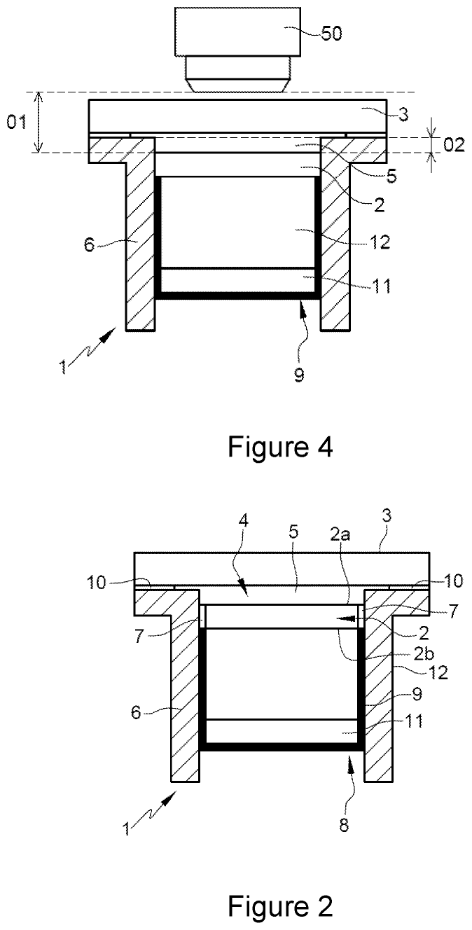

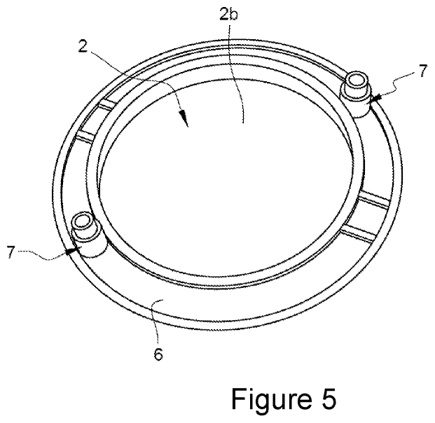

The invention will now be described in detail with reference to the figures listed above. The filtration device 1 according to the invention is intended for use in solid-phase cytometry. The filtration device 1 comprises a filtration membrane 2 configured to filter a sample (not shown). As shown in FIG. 2 in particular, the filtration membrane 2 has an upper face 2a and a lower face 2b, the biological sample being filtered from the upper face 2a to the lower face 2b. The filtration membrane is attached to a support 6. Ideally, the support 6 is arranged around the filtration membrane 2 as can be seen in FIG. 5. In this example shown in FIG. 5, the filtration membrane 2 is stretched and attached to the support 6.

The support 6 for the filtration membrane 2 has a lower housing 8 provided under the filtration membrane 2. The lower housing 8 opens onto the lower face 2b of the filtration membrane 2. The lower housing 8 is configured to receive one or more functionalized cartridges 9, which will be described below.

As shown in FIGS. 2 and 3, the filtration device 1 further comprises a coverslip 3 arranged above the upper face 2a of the filtration membrane 2. As can be seen, the coverslip 3 is arranged so as to cover the entire upper face 2a of the filtration membrane 2 in order, in particular, to protect the latter. The coverslip 3 is transparent to allow analysis. The coverslip 3 is rigidly secured to the filtration membrane 2 while maintaining an interstitial space 4. The interstitial space 4 is formed between the coverslip 3 and the upper face 2a of the filtration membrane 2, the interstitial space 4 being shaped to receive an interstitial fluid 5 as shown in FIG. 2. The interstitial space 4 also makes it possible to accommodate the sample (not shown) before filtration. The interstitial space 4 is sealed when the coverslip 3 is positioned above the filtration membrane 2. To be specific, the filtration device 1 comprises seals 10 for sealing off said interstitial space 4, as can be seen in particular in FIGS. 2 and 4.

Further details of the filtration device 1 will become apparent in the light of the description of the method which will now be set out in detail.

The microbiological analysis method according to the invention is a method for analysis by solid-phase cytometry.

To implement this analysis method, use is made of a filtration device 1 as described above.

The first step 101 of the analysis method consists in filtering the sample to be analyzed. The second step 102 of the analysis method is a step of labeling the microorganisms likely to be present in the biological sample, the labeling step 102 consisting in labeling the microorganisms with a fluorogenic substrate. The analysis method includes a third step, a step of detection 103 of the microorganisms labeled. The analysis method includes a fourth, optional step of confirmation 104 of detection by fluorescence microscope.

The method comprises a positioning step 110 in which the coverslip 3 is positioned above the upper face 2a of the filtration membrane 2 of the filtration device 1 and a step of adding interstitial fluid 112 into the interstitial space 4. Depending on the process steps, these two steps may be carried out at different times.

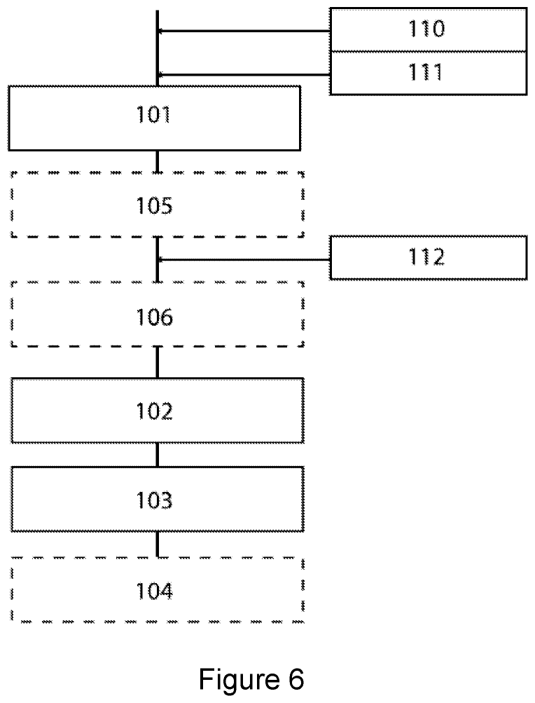

For example, as shown in FIG. 6, the step of positioning 110 the coverslip 3 is carried out before filtration 101, the addition step 112 is carried out after filtration 101 or after any step requiring filling of the interstitial space 4, such as for example the step of introducing the sample 111 or the counterstaining step 105 as shown in FIG. 6.

The step of introducing the sample 111, consisting in introducing the sample onto the upper face 2a of the filtration membrane 2, may be carried out via the port(s) 7 of the support 6 of the filtration device 1.

In the example shown in FIG. 6, the coverslip 3 is positioned (step 110) before filtration 101, and the sample is introduced (step 111) after positioning of the coverslip 3, which ensures optimal non-contamination of the biological sample. Following filtration, an optional counterstaining step 105 may be implemented (the step is indicated in dotted line in FIG. 6 since it is optional). When the counterstaining step 105 is implemented, the interstitial space 4 fills with counterstaining solution which is then filtered by the membrane. The step of adding interstitial fluid 112 takes place after the counterstaining step 105. When the counterstaining step is not implemented, the step of adding interstitial fluid 112 is implemented directly after filtration 110.

The step of adding interstitial fluid 112 may be carried out either:
by first soaking the filtration membrane 2 on its lower face 2b with a cartridge 9 comprising the interstitial fluid 5 and therefore allowing the interstitial fluid 5 in liquid form to rise up by capillarity via the pores in the filtration membrane 2 and fill the interstitial space 4,
by wetting the coverslip 3 with the interstitial fluid 5 in liquid form before placing it on the filtration membrane 2,
by turning over the pair formed of the filtration membrane 2 and coverslip 3 to access the lower face 2b of the filtration membrane 2 and allowing the interstitial fluid 5 in liquid form to settle by gravity in the interstitial space 4,
by injecting, once the coverslip 3 has been deposited (step 110), the interstitial fluid 5 in liquid form via the port(s) 7 of the support 6 of the filtration membrane 2,
by positioning the pair formed of the filtration membrane 2 and coverslip 3 vertically and injecting the interstitial fluid 5 in liquid form from bottom to top to expel the air bubbles.

As shown in FIG. 6, the next step is an optional pre-labeling step 106 (the step is indicated in dotted line in FIG. 6 since it is optional), consisting of an activation to resuscitate the spores present in the sample and guarantee optimal enzymatic activity. The sample corresponds to a certain physiological state of the microorganisms, with a very reduced metabolism. Next comes the step of labeling 102 of the microorganisms. During the pre-labeling 106 and labeling 102 steps, functionalized cartridges 9 may be used as shown in FIG. 3. These functionalized cartridges 9 may be, depending on the step: a reagent 12 or a medium for the activation of spores 12, or a cartridge for fluorescent labeling or a cartridge for deactivating labeling. These cartridges 9 are inserted in the support 6 of the filtration device 1 in order to be in contact with the lower face 2b of the filtration membrane 2 on which the microorganisms of the biological sample are retained.

The pre-labeling 106 and labeling 102 steps may also be implemented by a single functionalized cartridge having two types of particles (A) and (B) with different release times. Thus, the labeling substrate may be diffused first, followed by, after a programmed labeling time, a reagent which “bleaches” and extinguishes labeling, such as a strong reducing agent. With such a device, use may be made of a single cartridge, with a culture gel 12, which allows all 3 operations: activation, labeling, and stopping of labeling.

Lastly, the microorganisms collected on the filtration membrane 2 are analyzed in two steps: the detection step 103 and the confirmation step 104.

It is also possible to add a microorganism culturing step in order to increase the mass of microorganisms with a view to more efficient detection: a functionalized cartridge of culture media may be envisaged or the culturing of the filtration membrane 2 is also envisaged. In this step (not shown), two types of cartridge may be envisaged depending on whether the aim is to detect and grow aerobic or anaerobic germs. The gas 11 present in the functionalized cartridge 9, as shown in FIGS. 2, 3 and 4, for aerobes contains oxygen and that for anaerobes is without oxygen.

The detection step 103 is carried out by fluorescence imaging, in Laser Scanning and/or Full Field and/or Image Mosaic mode.

The step of confirmation of detection 104 may be carried out using an air objective or an immersion objective, the coverslip 3 allowing the use of both of these objectives.

FIG. 4 shows a diagram of possible implementation, with a gel interstitial layer and the thickness of interest for detection, with 01 representing the objective focusing range and 02 the maximum working distance of the objective, and the reference numeral 50 designating the objective.

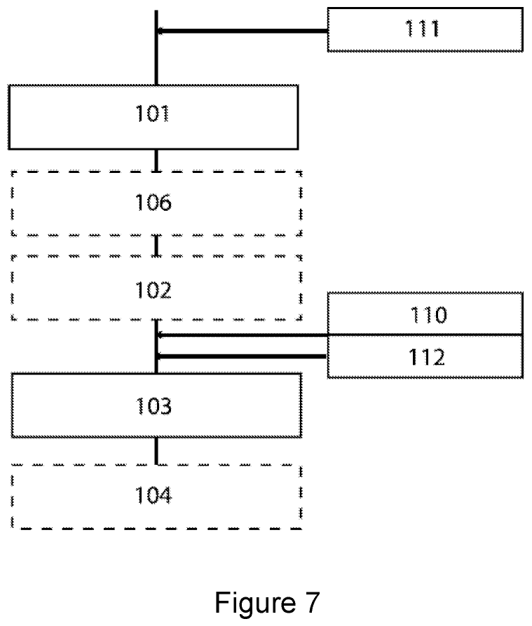

FIG. 7 also shows the method of the invention but with the coverslip 3 only added before analysis (steps 103 and 104).

Furthermore, prior to step 111 of introducing the biological sample, it is possible to prepare the biological sample so that it is filterable.

Of course, the invention is not limited to the embodiments described and shown in the appended figures. Modifications remain possible, notably in terms of the constitution of the various elements or of the substitution of technical equivalents, yet without departing from the scope of protection of the invention.

1. A filtration device for use in solid-phase cytometry, said filtration device being configured to filter a sample likely to contain microorganisms and allow analysis thereof, the filtration device comprising:
a filtration membrane configured to filter the biological sample, the filtration membrane having an upper face and a lower face,
characterized in that the filtration device further comprises at least:
a coverslip arranged above the upper face of the filtration membrane, the coverslip being arranged so as to cover the entire upper face of the membrane,
an interstitial space formed between the coverslip and the upper face of the filtration membrane, the interstitial space being shaped to receive a fluid.

2. The filtration device as claimed in claim 1, comprising an interstitial fluid housed in the interstitial space, the fluid being a liquid or a gel.

3. The filtration device as claimed in claim 1, wherein the coverslip is rigidly secured to the filtration membrane while maintaining the interstitial space.

4. The filtration device as claimed in claim 1, comprising at least one support on which the filtration membrane is positioned, said support having at least one port in communication with the upper face of the membrane.

5. The filtration device as claimed in claim 4, wherein the support comprises a lower housing, formed under the filtration membrane, the lower housing being shaped to receive a functionalized cartridge intended to come into contact with the lower face of the membrane.

6. The filtration device as claimed in claim 5, comprising at least one functionalized cartridge, said functionalized cartridge possibly being a reagent or a culture medium or a medium for activating spores, or a cartridge for fluorescent labeling or a cartridge for deactivating labeling and/or for keeping the filtration membrane soaked.

7. A method for microbiological analysis by solid-phase cytometry using a filtration device as claimed in claim 1, the analysis method comprising at least the following steps:
a step of filtration of the sample by the filtration membrane,
a step of fluorescence labeling of the microorganisms likely to be present in the biological sample,
a step of detection of the labeled microorganisms,
the method being characterized in that it comprises at least one step according to which the coverslip is positioned above the upper face of the filtration membrane of the filtration device.

8. The method for microbiological analysis by solid-phase cytometry as claimed in claim 7, wherein the coverslip is positioned above the upper face of the filtration membrane of the filtration device before the filtration step and an additional step of adding an interstitial fluid into the interstitial space of the filtration device is carried out after the filtration step.

9. The method for microbiological analysis by solid-phase cytometry as claimed in claim 7, wherein the sample is injected onto the upper face of the filtration membrane via the port(s) of the support of the filtration device.

10. The method for microbiological analysis by solid-phase cytometry as claimed in claim 7, wherein the coverslip is positioned above the upper face of the filtration membrane of the filtration device and the interstitial fluid is added into the interstitial space of the filtration device before the detection step.
